(19) United States
(12) Patent Application Publication
(10) Pub. No.: US 2015/0182994 A1
(43) Pub. Date: Jul. 2, 2015

(54) INFRARED PULSE RADIATION HEATING METHOD FOR CURING BOARD SURFACE POWDER AND DEVICE THEREOF

(71) Applicant: SHANDONG LANGFARBE POWDER COATING TECHNOLOGY CO., LTD., Qingdao City, Shandong Province (CN)

(72) Inventors: Shiyue Zhou, Zibo City (CN); Xintao Dou, Zibo City (CN); Yefeng Hu, Zibo City (CN)

(21) Appl. No.: 14/387,480

(22) PCT Filed: Mar. 15, 2013
(86) PCT No.: PCT/CN2013/000238

§ 371 Date: Sep. 23, 2014

(30) Foreign Application Priority Data
Mar. 23, 2012 (CN) 201210078997.3

(51) Int. Cl. B05D 3/02; B27N 7/00; H05B 3/00

(52) U.S. Cl. CPC B05D 3/0263; H05B 3/0038; B27N 7/005

(57) ABSTRACT

An infrared pulse radiation heating method for curing board surface powder comprises melting and curing sequentially performed. The curing is to make a board, with a film formed by quickly melting a power coating, pass through a medium wave infrared pulse radiation area to be heated, the heating is performed alternatively at a high temperature and a low temperature, the medium wave infrared pulse radiation area is formed by separate medium wave infrared pulse radiation heating units consecutively arranged, and medium wave infrared heating tubes in the medium wave infrared pulse radiation area are vertically arranged. Further provided is a device for implementing the heating method. By means of the method and the device, thermal damage is prevented from being incurred to the board, the coated film is uniformly cured, and the energy-conserving effect is improved.

### FIELD OF THE INVENTION

The invention relates to an infrared pulse radiation heating method for curing board surface powder and a device thereof, belonging to the field of infrared technology application.

### BACKGROUND OF THE INVENTION

At present, after the surfaces of man-made boards such as MDF boards, HDF boards, LDF boards and shaving boards and the like on the market are coated with powder coatings, the release concentration of harmful substances formaldehyde in the boards can be greatly reduced; because the powder coatings are 100% solids, the powder coatings are uniformly coated on the surfaces of the man-made boards; therefore, the man-made boards become favorite green and environmental-friendly products for people; for example, the release amount of formaldehyde in a raw sheet of a shaving board is 2.8 mg/L, and after the shaving board is coated with a powder coating by electrostatic spraying, the release amount of formaldehyde is reduced to 0.1 mg/L. Because boards can not stand high temperature actions, a UV photo-curing powder electrostatic coating technology is developed abroad, but due to reasons such as expensive equipment, high coating cost, high difficulty of process control, and the like, the popularization and application of the UV photocuring powder electrostatic coating technology are restricted.

A medium wave infrared radiation technology has been successfully applied in the electrostatic powder coating of MDF boards for the near term. A medium wave infrared heating technology has an advantage that heat provided for a MDF man-made board can be reasonably allocated so as to increase the heat getting ratio of a coated film on the surface of the board and accelerate the heat absorption speed of the coated film as far as possible, namely, the heat is transferred to the coated film in the shortest possible time, so that the coated film is cured quickly, thereby shortening the curing time; and because the heated time of the substrate is shortened, the heat absorption of a substrate of the board is greatly reduced, so that the temperature of the substrate of the board is lower than 100 DEG C when being taken out of a drying tunnel. In such a way, the curing quality of the coated film is ensured, the energy consumption can be greatly reduced (compared with traditional circulating hot-air drying tunnels), and the length of the drying tunnel is shortened.

But in the medium wave infrared radiation technology, for solving a problem of enabling each part of a workpiece to be heated uniformly in an effective heating area, an enough distance still must be kept between a medium wave infrared tube in a device and the workpiece, therefore, the space of an inner cavity of the heating area in the device is relatively large. At present, in the medium wave infrared radiation technology, a medium wave infrared radiation heating drying tunnel manufactured by famous Hereaues is relatively representative. Infrared lamp tubes in the drying tunnel are horizontally arranged parallel to the length direction of the drying tunnel, and the heating concept of the infrared lamp tubes is to strive for achieving that uniform radiation is provided in the heating area of the drying tunnel and workpieces are located in a uniform temperature field, so the upper, middle and lower horizontal arrangement of the medium wave infrared tubes in the drying tunnel is required to be precisely calculated, the demands of arrangement are high, the distance between a medium wave infrared tube and a workpiece is far, and the space length of the inner cavity of the drying tunnel is large.

On Jan. 21, 2011, an article ‘improve the uniformity of powder coating spraying on MDF boards’ published by Guangzhou Electric Apparatus Research Institute on Guangzhou Innovative Approach net pointed out that: some difficulties still exist in applying powder coatings to the coating of boards. Currently, the key equipment is a curing furnace, and the biggest problem is non-uniform curing, especially a problem that the curing of a side face is inadequate, and some places on a surface are also not cured completely; and solving the problem above still belongs to an advanced technology in domestic. The Institute is selecting infrared tubes to research the uniformity of board curing through analysis by using innovative approaches and MPV tools; through the application of a prior action principle, a periodic action principle, an object-field model and the like of the innovative approaches, five solutions are proposed, and ‘cyclical movement of lamp tubes and reflective boards’ is regarded as the optimal candidate solution; and through verification test, a desired effect is still not achieved, and follow-up researches are also required to be performed. For design, manufacture and use safety and reliability concerns, the dynamic curing drying tunnel has many technical difficulties, therefore, the drying tunnel can not be used as an ideal practical curing device for MDF boards at present.

The prior art shows that a continuous close radiation heating mode is not feasible for MDF man-made boards; because the thermal conductivity of man-made boards is far lower than that of metals, heat received by the surfaces of the man-made boards only can be slowly transferred to the deep parts of the boards, so that the surfaces of the man-made boards can not bear high temperature for a long time, otherwise, the surface layers of the man-made boards are subjected to thermal damages or volatile gas is decomposed and released to destroy coated films, therefore, when a coated film on the surface of a MDF board is cured by using a conventional medium wave infrared radiation drying tunnel, a larger heating area space is required, which undoubtedly reduces the energy saving effect thereof; and the difficulty is one of key technologies to be solved by a ‘medium wave infrared pulse radiation heating technology’ disclosed by the invention.

To solve a demand that the upper and lower parts of workpieces are heated consistently in a traditional medium wave infrared radiation drying tunnel which is of a suspension conveying chain structure, the accurate design on the reasonable arrangement of upper and lower horizontal lamp tubes is required so as to ensure that the upper and lower parts of workpieces are same in radiation intensity (include a superimposed effect of radiation). For achieving the purpose, as has been pointed out in ‘improve the uniformity of powder coating spraying on MDF boards’ published by Guangzhou Electric Apparatus Research Institute, it is an advanced scientific research subject required to be researched and broken through for current infrared radiation heating drying tunnels for MDF man-made boards. According to the invention, the adoption of a mode of vertically arranging medium wave infrared tubes and the application of a concept ‘equiprobable non-uniformity achieves uniformity’ can realize the breakthrough of the technical difficulty.

### SUMMARY OF THE INVENTION

The invention aims to solve the technical problem of providing an infrared pulse radiation heating method for curing board surface powder and a device thereof; by using the method, coated films are cured uniformly so as to ensure that the surfaces of boards in an automatic coating production line are in a same heated state; and the invention also provides a device for implementing the method.

The infrared pulse radiation heating method for curing board surface powder provided by the invention comprises melting and curing sequentially performed, wherein the curing is to make a board, with a film formed by quickly melting a power coating, pass through a medium wave infrared pulse radiation area to be heated, the heating is performed alternatively at a high temperature and a lower temperature, the medium wave infrared pulse radiation area is composed of single medium wave infrared pulse radiation heating units consecutively arranged, and medium wave infrared heating tubes in the medium wave infrared pulse radiation area are vertically arranged.

The working curve of the single medium wave infrared pulse radiation heating unit is shown at: temperature rise-high temperature-temperature reduction, namely, the surface of a coated film is heated to 150-180 DEG C, and after being cured at the temperature, the coated film is cooled to 120-140 DEG C, so that one medium wave infrared pulse radiation heating is completed.

In the working curve of the single medium wave infrared pulse radiation heating unit, the time of each stage is generally determined according to the running speed of a conveying chain in a drying tunnel, and the conveying chain carries out a uniform linear motion at a speed of 1-2 m/min generally, at this moment, the working curve is shown as follows: in the first second, the surface of a coated film is heated to 150-180 DEG C, then the coated film is cured for 3-5 seconds at the temperature, and finally, the coated film is cooled to 120-140 DEG C for 14-18 seconds, so that one medium wave infrared pulse radiation heating is completed in a total time of 18-24 seconds. The melting is to make a board coated with a power coating pass through a medium wave infrared radiation area to be heated, so that a flat and smooth coated film is obtained; and medium wave infrared heating tubes in the medium wave infrared radiation area are vertically and densely arranged.

The device for implementing the heating method is in drying tunnel form, and comprises a melting section and a curing section, wherein the melting section is divided into a heating section and a cooling section, a medium wave infrared radiation heating apparatus is symmetrically arranged on both sides of the heating section, the apparatus is composed of multiple medium wave infrared heating tubes which are vertically and densely arranged, and the apparatus is fixedly connected with an external radiation distance adjuster; and a medium wave infrared pulse radiation heating apparatus is symmetrically arranged on both sides of the curing section, the apparatus is composed of pulse radiation heaters which are uniformly arranged at certain interval, each pulse radiation heater is composed of vertically arranged single or double medium wave infrared heating tubes, and the medium wave infrared pulse radiation heating apparatus is fixedly connected with an external radiation distance adjuster.

The medium wave infrared radiation heating apparatus is fixedly connected with an external corresponding radiation distance adjuster by a bracket arranged on the heating apparatus.

The medium wave infrared pulse radiation heating apparatus is fixedly connected with an external corresponding radiation distance adjuster by the bracket arranged on the heating apparatus, and a fixed pin is used for positioning.

One end of an adjusting rod of the radiation distance adjuster is connected with the bracket, through holes are uniformly distributed on the adjusting rod, the other end of the adjusting rod is nested in a guide tube with a through hole, the guide tube is fixedly connected with a drying tunnel wall, and the guide tube and the adjusting rod are connected by the fixed pin on the outer side of the drying tunnel wall.

The medium wave infrared radiation heating apparatus is connected with a melting-section voltage regulator.

The medium wave infrared pulse radiation heating apparatus is connected with a curing-section voltage regulator.

The top of the inner cavity of the drying tunnel is provided with an air blow pipe, the bottom of the inner cavity of the drying tunnel is provided with an air suction pipe, and the air blow pipe and the air suction pipe are respectively connected with a fan.

The minimum vertical distance between one medium wave infrared heating tube and the single side of a heated board is 120-200 mm.

The radiation distance adjusters used by the medium wave infrared radiation heating apparatus and the medium wave infrared pulse radiation heating apparatus are same in structure and application method, and an appropriate number of adjusting rods can be set according to the length of the bracket.

The invention has the following technical characteristics:

1, Due to the application of equiprobable non-uniform radiation and the vertical arrangement of the medium wave infrared tubes, coated films on the surfaces of workpieces are uniformly cured.

The radiation power density of the medium wave infrared tubes is uniformly distributed along the length direction of a lamp tube. The design on a medium wave infrared pulse radiation drying tunnel does not focus on the uniformity of temperature in the length direction of the drying tunnel, but is required to ensure that all radiation energy received by the surface of a workpiece is equal, so that it is the key to achieve uniform radiation along the vertical direction of the drying tunnel, therefore, the medium wave infrared tubes must be vertically arranged (perpendicular to the Z-axis direction of the bottom of the drying tunnel) on both sides of the inner wall of the drying tunnel, as shown in FIG. 1.

The uniformity of temperature of air in upper and lower areas is adjusted by using up-to-down convective circulating hot air in the drying tunnel, the air blow pipe and the air suction pipe are respectively connected with the fan, and the fan is connected with a motor. As shown in FIG. 5, in the process of operating, the air blow pipe blows air outwards, and after the air is sucked by the air suction pipe, a circulating fan blows out the air sucked by the air suction pipe through the air blow pipe, so that a circle is formed.

Radiation heat in the Z-axis direction, received by a workpiece at every moment in the process of conveying, is uniform, but infrared radiation heat received by points on an X-axis in the motion direction is changed in pulse wave form, that is to say the temperature distribution of the drying tunnel along the length direction is a temperature field with large changes, but just by ensuring that the probability of receiving the non-uniform radiation by each workpiece when the drying tunnel is running is equal, the heated curing states of parts of the workpiece are completely consistent, all above refers to a concept ‘equiprobable non-uniform radiation solves the implementation of uniform curing of coated films’, therefore, the arrangement position and direction of the medium wave infrared tubes in the drying tunnel and the stability of conveying chain running of the production line are important factors for ensuring the uniform curing of coated films of workpieces.

2, The adoption of a medium wave infrared pulse radiation heating unit technology can solve a problem that the surface layer of a MDF board is not subjected to high-temperature thermal damage. A single medium wave infrared pulse radiation heating unit is implemented by three temperature processes including temperature rise, high temperature and temperature reduction, as shown in FIG. 2, i.e. the surface of a coated film is heated to 150-180 DEG C, and after being cured at the temperature, the coated film is cooled to 120-140 DEG C, so that one medium wave infrared pulse radiation heating is completed.

The pulse infrared radiation heating is an intermittent small-dose radiation heating method, by which the surface layer of a board has abundant time to transfer heat to the deep parts of the board, thereby avoiding that the surface layer of the board has thermal damage. Heat caused by infrared radiation is absorbed for heating by a coated film firstly, and then transferred to a substrate of the board through the surface layer of the board. Therefore, as long as the surface layer has abundant time to dissipate time to the deep parts of the board, the temperature of the board does not rise quickly by accumulating.

Due to the infrared pulse radiation heating unit technology, the proportion of energy distribution obtained by a coated film is greatly improved, so that a situation that the coated film is in a high-temperature curing state is kept, and the total curing time is correspondingly reduced. The total radiation energy received by the board is reduced, and the heat capacity of a substrate of the board is far greater than that of a coated film covered on the surface of the substrate of the board. Therefore, when the coated film is fully cured, the substrate of the board still can be in a relatively low-temperature state.

3, By aid of a cumulative effect of pulse high-temperature curing, the curing time of a coated film is shortened.

In an Arrhenius law, an exponential curve relation is formed between chemical reaction rate and temperature, and can be described approximately by using a 10 DEG C law, i.e. the chemical reaction rate is doubled once the curing temperature is increased by 10 DEG C, that is to say, the time required for completing the curing is reduced by 50%. A powder coating under the curing condition of 130 DEG C/20 min is taken as an example, and a corresponding relation between curing temperature and curing time is shown in Table 1.

TABLE 1
corresponding relation between curing temperature and curing time

| | curing temperature Tx/DEG C. | | | | | |
|---|---|---|---|---|---|---|
| | 130 | 140 | 150 | 160 | 170 | 180 |
| curing time tx/S | 1200 | 600 | 300 | 150 | 75 | 37.5 |
| compared with the curing | 1 | 2 | 4 | 8 | 16 | 32 |
| time under the condition of | | | | | | |
| 130 DEG C., the curing time | | | | | | |
| under the condition of Tx is | | | | | | |
| shortened by n times | | | | | | |

Practices show that when a MDF board is at an instantaneous high temperature of 160-180 DEG C, the surface of the board does not have thermal damage, therefore, in the process of heating, as long as the sum of high-temperature curing time in all pulse heating reaches 150-40 seconds, the curing of a coated film can be completed. For safety margin concerns, a high temperature of 160 DEG C selected by a pulse drying tunnel is designed, so that the corresponding curing time is 150 seconds; and compared with the curing time under the condition of 130 DEG C, the curing time under the condition of 160 DEG C is shortened by eight times, therefore, the cumulative effect of pulse instantaneous high-temperature actions can effectively accelerate the coating curing of the coated film.

The method disclosed by the invention comprises the following operation steps that:

(1) a MDF board coated with a powder coating passes through a pulse radiation drying tunnel according to the requirements of the medium wave pulse radiation heating units and the vertical arrangement of the medium wave infrared tubes;

(2) when the board passes through a melting section, the powder coating is quickly melted and leveled, and then cooled to 120-140 DEG C; and

(3) when the board passes through a curing section, each medium wave infrared pulse radiation heating unit area carries out short-term high-temperature strong radiation and cooling (low-temperature) alternate curing on the coated film; and

the working curve of each medium wave infrared pulse radiation heating unit shows that the surface of the coated film is heated to 150-180 DEG C, and after being cured at the temperature, the coated film is cooled to 120-140 DEG C, so that one medium wave infrared pulse radiation heating is completed.

Through an accumulative curing effect achieved by the heating of all the medium wave infrared pulse radiation units of the curing section, the curing of the coated film of the MDF board is quickly completed, and the board is kept in a safe low-temperature state.

The invention has the following beneficial effects that:

In the heating method disclosed by the invention, a new concept of medium wave infrared pulse radiation heating units is used, and a method for carrying out pulse high-temperature curing on a powder coating on the surface of a board by using short-term pulse high-temperature is adopted, so that the occurrence of thermal damage on the surface of the board is avoided. By aid of the cumulative effect of pulse high-temperature curing, the curing time of a coated film is greatly shortened, and the heat absorption capacity of a substrate of the board is greatly reduced, thereby ensuring that the MDF man-made board can be in a low-temperature state of below 100 DEG C when being taken out of a furnace.

According to the invention, on the basis of an equiprobable non-uniform radiation concept, a mode of vertically arranging the medium wave infrared tubes is adopted in the drying tunnel, so that a coated film on the surface of each workpiece running in the production line achieves equivalent uniform curing. Compared with a traditional concept of pursuing the identity of temperature uniformity of a drying tunnel, the pulse wavelike non-uniform radiation heating drying tunnel has fundamental differences.

The device for implementing the technique can narrow effective heating space and length, therefore, a situation that the surfaces of MDF boards in an automatic coating production line are in a same heated state is ensured, so that coated films are uniformly cured; and an energy saving effect is very significant. The method is especially suitable for being used as a heat treatment method for quickly melting and curing powder coatings on flat-plate products such as MDF boards and plastic products and the like.

### BRIEF DESCRIPTION OF THE DRAWINGS

FIG. 1 is a vertical arrangement diagram of the medium wave infrared tubes in the drying tunnel;

FIG. 2 is a time curve chart of the medium wave infrared pulse radiation unit in the invention;

FIG. 3 is a structural schematic diagram of the medium wave infrared pulse radiation drying tunnel in the invention;

FIG. 4 is a structural schematic diagram of the radiation distance adjuster in the invention; and

FIG. 5 is a structural schematic diagram of air duct arrangement in the drying tunnel in the invention.

In the figures: 1, drying tunnel; 2, medium wave infrared heating tube; 3, bracket; 4, medium wave infrared pulse radiation heating apparatus; 5, pulse radiation heater; 6, medium wave infrared radiation heating apparatus; 7, MDF board; 8, melting-section voltage regulator; 9, channel; 10, curing-section voltage regulator; 11, adjusting rod; 12, guide pipe; 13, fixed pin; 14, drying tunnel wall; 15, circulating fan; 16, motor; 17, air blow pipe; 18, air suction pipe; A, single medium wave infrared pulse radiation heating time unit; B, melting section; C, curing section; D, cooling section in the melting section; E, radiation area in the medium wave infrared pulse radiation heating unit; F, cooling section in the medium wave infrared pulse radiation heating unit; S1, distance between the melting section and a board; and S2, distance between the curing section and a board.

### DETAILED DESCRIPTION OF THE EMBODIMENTS

The following further describes the invention in combination with embodiments.

### Embodiment 1

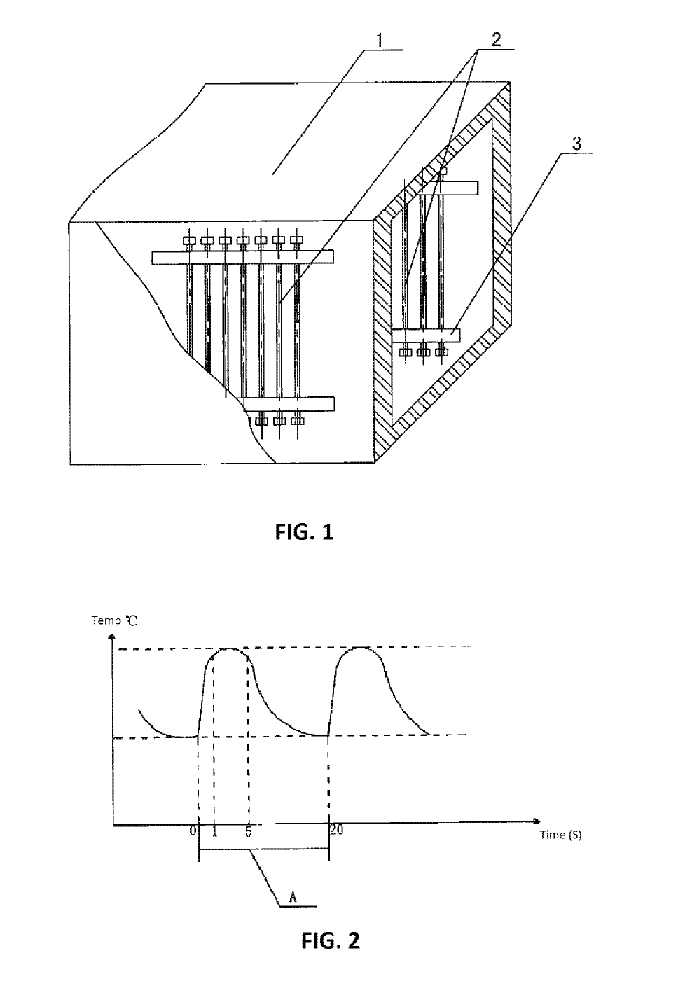

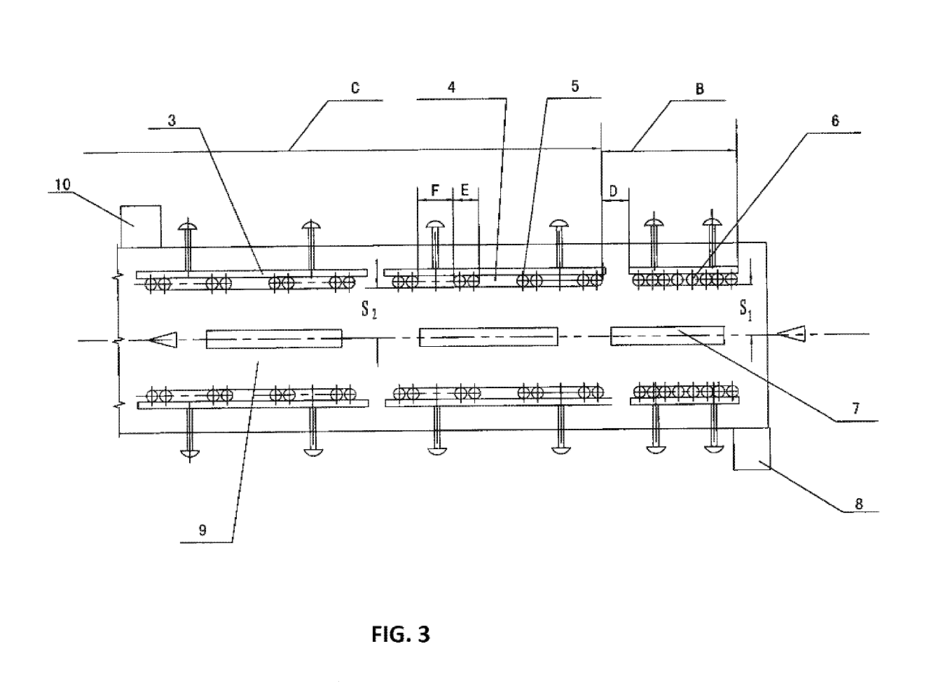

As shown in FIG. 1-5, a MDF board is taken as an example in the embodiment:

1, the infrared pulse radiation heating method for curing board surface powder disclosed by the invention comprises melting and curing sequentially performed. The curing is to make the MDF board 7 coated with a power coating pass through a medium wave infrared pulse radiation area to be heated, the heating is performed alternatively at a high temperature and a lower temperature, the medium wave infrared pulse radiation area is composed of single medium wave infrared pulse radiation heating units consecutively arranged, and medium wave infrared pulse radiation tubes 2 in the medium wave infrared pulse radiation area are vertically arranged.

The working curve of the single medium wave infrared pulse radiation heating unit is shown at: temperature rise-high temperature-temperature reduction, namely, the surface of a coated film is heated to 160 DEG C, and after being cured at the temperature, the coated film is cooled to 120-140 DEG C, so that one medium wave infrared pulse radiation heating is completed.

In the working curve of the single medium wave infrared pulse radiation heating unit, the time of each stage is generally determined according to the running speed of a conveying chain in a drying tunnel, and the conveying chain carries out a uniform linear motion at a speed of 1.5 m/min generally, at this moment, the working curve shows as follows: in the first second, the surface of the coated film is heated to 160 DEG C, then the coated film is cured for 4 seconds at the temperature, and finally, the coated film is cooled to 130 DEG C for 15 seconds, so that one medium wave infrared pulse radiation heating is completed in a total time of 20 seconds.

The melting is to make the MDF board 7 coated with a power coating pass through a medium wave infrared radiation area to be heated, so that a flat and smooth coated film is obtained; and the medium wave infrared heating tubes 2 in the medium wave infrared radiation area are vertically and densely arranged.

2, the structure of the drying tunnel

The drying tunnel for implementing the heating method comprises a melting section B and a curing section C, wherein the melting section B is divided into a heating section and a cooling section D, a medium wave infrared radiation heating apparatus 6 is symmetrically arranged on both sides of the heating section, the apparatus is composed of multiple medium wave infrared heating tubes 2 which are vertically and densely arranged, and the apparatus is fixedly connected with an external corresponding radiation distance adjuster; and a medium wave infrared pulse radiation heating apparatus 4 is symmetrically arranged on both sides of the curing section C, the apparatus is composed of pulse radiation heaters 5 which are uniformly arranged at certain interval, the pulse radiation heater 5 is composed of vertically arranged single or double medium wave infrared heating tubes, and the medium wave infrared pulse radiation heating apparatus 4 is fixedly connected with an external corresponding radiation distance adjuster.

The medium wave infrared radiation heating apparatus 6 is fixedly connected with an external corresponding radiation distance adjuster by a bracket 3 arranged on the heating apparatus.

The medium wave infrared pulse radiation heating apparatus 4 is fixedly connected with an external corresponding radiation distance adjuster by the bracket 3 arranged on the heating apparatus.

One end of an adjusting rod 11 of the radiation distance adjuster is connected with the bracket 3, through holes are uniformly distributed on the adjusting rod 11, the other end of the adjusting rod 11 is nested in a guide tube 12 with a through hole, the guide tube 12 is fixedly connected with a drying tunnel wall 14, and the guide tube 12 and the adjusting rod 11 are connected by a fixed pin 13 on the outer side of the drying tunnel wall 14. The fixed pin 13 is used for positioning.

The medium wave infrared radiation heating apparatus 6 is connected with a melting-section voltage regulator 8.

The medium wave infrared pulse radiation heating apparatus 4 is connected with a curing-section voltage regulator.

The minimum vertical distance between the medium wave infrared heating tube 2 and the single side of the heated MDF board is 120 mm.

The specific structure and operations of the drying tunnel are as follows:

(1) the medium wave infrared radiation heating device 6 of the melting section is composed of 12 medium wave infrared heating tubes 2 which are vertically and densely arranged, and fixedly connected with an radiation distance adjustor. A powder coating on the surface of the MDF board 7 and entering the melting section is quickly heated to 160 DEG C from room temperature, and then melted and leveled. The vertical distance between one side of the MDF board 7 and the medium wave infrared heating tube 2 is 100 mm.

(2) an area D is a cooling section after a coated film is melted, and a powder coated film is quickly cooled to 130 DEG C.

(3) a medium wave infrared pulse radiation heater 5 of the curing section C is composed of two medium wave infrared heating tubes 2. A coated film of the MDF man-made board passes through an radiation area E, so that one temperature-rise and high-temperature radiation heating process in the medium wave infrared pulse radiation heating apparatus is completed, the process is implemented in 5 seconds, and the medium wave infrared pulse radiation heating apparatus 4 is fixedly connected with the radiation distance adjuster.

(4) an area F is a cooling section in the infrared pulse radiation heating unit, in the section, the coated film still continues to be cured at a temperature of 130 DEG C, but the curing rate is gradually reduced to below 130 DEG C, and the time of implementing the curing rate reduction is 15 seconds.

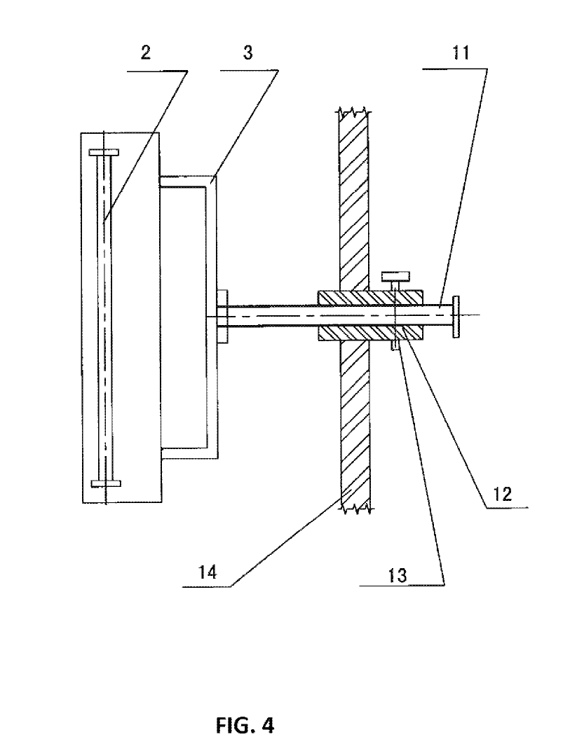

(5) the adjustment of the radiation distance S is implemented by the radiation distance adjustor. As shown in FIG. 4, the moving of the adjusting rod 11 in the guide pipe 12 can adjust the radiation distance S. Through holes are uniformly distributed on the adjusting rod 11, the pipe section of the guide pipe 12 is provided with a through hole on the outer side of the drying tunnel wall 14, and the fixed pin 13 passes through the through holes of the guide pipe 12 and the adjusting rod 11, so that the radiation distance adjustor can be located at a required position.

(6) the top and bottom of the inner cavity of the drying tunnel 1 are respectively provided with a medium wave infrared tube 2 in a direction consistent with the length direction of the drying tunnel 1, the medium wave infrared tubes 2 are respectively used as a top lamp and a bottom lamp for curing the upper edge and bottom edge of the board, and corresponding voltage regulators are equipped.

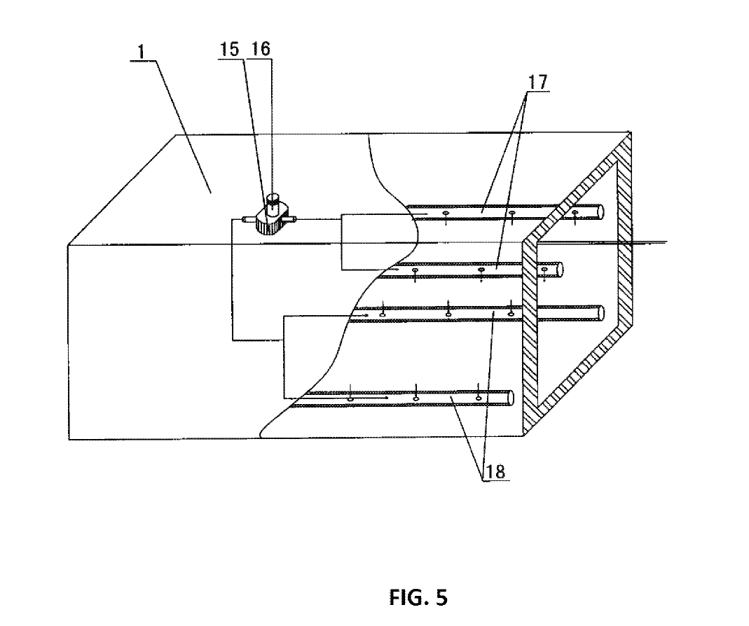

(7) the uniformity of temperature of air in upper and lower areas is adjusted by using up-to-down convective circulating hot air in the drying tunnel 1, The top of the inner cavity of the drying tunnel 1 is provided with an air blow pipe 17, the bottom of the inner cavity of the drying tunnel is provided with an air suction pipe 18, the air blow pipe 17 and the air suction pipe 18 are respectively connected with a circulating fan 15, and the circulating fan 15 is provided with a motor 16. As shown in FIG. 5, in the process of operating, the air blow pipe 17 blows air outwards, and after the air is sucked by the air suction pipe 18, the circulating fan 15 blows out the air sucked by the air suction pipe 18 through the air blow pipe 17, so that a circle is formed. 3, the calculation on the number m of the pulse radiation heaters 5 configured on both sides of the curing section C of the drying tunnel is implemented by taking a powder coating under a curing condition of 130 DEG C/20 min as an example:

FIG. 2 shows that once the coated film passes through one pulse radiation heating unit in the curing section of the drying tunnel, the coated film will be subjected to one high-temperature curing for 5 seconds and one relatively-low-temperature curing for 15 seconds at a temperature of 130 DEG C. Table 1 shows that the curing effect achieved by that the coated film is cured for 1 second at a temperature of Tx is equivalent to the cutting effect achieved by the coated film is cured for n seconds at a temperature of T130 DEG C, therefore, the curing effect achieved by one pulse radiation heating is equivalent to the curing effect achieved by curing for (5n+15) seconds at a temperature of T130 DEG C. For safety margin concerns, the temperature Tx of the drying tunnel is designed to be equal to 160 DEG C, and Table 1 shows that n=8.

For enabling the curing degree of a coated film to be equivalent to that of a coated film cured for 1200 seconds at a temperature of 130 DEG C, the number m of times of infrared radiation pulse required to be borne is calculated in accordance with the following formula:

(5n+15)m=1200,m=21.8

By taking a round-off number, the two sides of the inside of the drying tunnel are respectively equipped with 22 pulse radiation heaters.

4, the determination of the length of the curing section C of the drying tunnel the running speed V of the conveying chain of the drying tunnel: V=1.5 m/min=0.025 m/sec

the running distance of a workpiece passing through one pulse radiation heating unit:

E+F=(5+15)V=0.5 m

the total length of the curing section of the drying tunnel: L=22(E+F)=11 m

Because the minimum temperature of the cooling section is 130 DEG C, the actual curing speed of the coated film will be faster, therefore, the length of the curing section of the drying tunnel can be less than 11 m. If the time for curing a same kind of powder by using a traditional circulating hot-air drying tunnel needs over 20 minutes, the length of the drying tunnel is required to be over 30 m.

From the foregoing, we can know that the drying tunnel in the invention can narrow effective heating space and length, therefore, a situation that the surfaces of MDF boards in an automatic coating production line are in a same heated state is ensured, so that a coated film is uniformly cured; and an energy saving effect is very significant.

In a production-oriented test wire for a medium wave infrared pulse radiation drying tunnel manufactured according to the invention, coating production practices show the feasibility and practicability of the new heating technology. Various specifications of furniture such as shaving board working tables and kid's tables and chairs and the like for medical equipment with a size of length*width*thickness=1400*800*30 mm have been successfully coated, and long tables and lockers and the like for dining rooms have been produced in batches by coating.

1-11. (canceled)

12. A device for implementing an infrared pulse irradiation heating method for curing board surface power, implemented in a drying tunnel mode, comprising a melting section and a curing section,
wherein the melting section is divided into a heating section and a cooling section, a medium wave infrared irradiation heating apparatus is symmetrically arranged on both sides of the heating section, the apparatus is composed of medium wave infrared heating tubes which are vertically and densely arranged, and the medium wave infrared irradiation heating apparatus is fixedly connected with an external corresponding irradiation distance adjuster; and a medium wave infrared pulse irradiation heating apparatus is symmetrically arranged on both sides of the curing section, the apparatus is composed of pulse irradiation heaters which are uniformly arranged at certain interval, the pulse irradiation heater is composed of vertically arranged single or double medium wave infrared heating tubes, and the medium wave infrared pulse irradiation heating apparatus is fixedly connected with an external corresponding irradiation distance adjuster, and
wherein the heating method comprises melting and curing sequentially performed, wherein the curing is to make a board, with a film formed by quickly melting a power coating, pass through a medium wave infrared pulse irradiation area to be heated, the heating is performed alternatively at a high temperature and a lower temperature, the medium wave infrared pulse irradiation area is composed of single medium wave infrared pulse irradiation heating units consecutively arranged, and medium wave infrared pulse irradiation tubes in the medium wave infrared pulse irradiation area are vertically arranged.

13. The device for implementing the heating method according to claim 12, wherein the working curve of the single medium wave infrared pulse irradiation heating unit is shown at: temperature rise-high temperature-temperature reduction, namely, the surface of the coated film is heated to 150-180 DEG C, and after being cured at the temperature, the coated film is cooled to 120-140 DEG C, so that one medium wave infrared pulse irradiation heating is completed.

14. The device for implementing the heating method according to claim 12, wherein the melting is to make a board coated with a power coating pass through a medium wave infrared irradiation area to be heated, and the medium wave infrared heating tubes in the medium wave infrared irradiation area are vertically arranged.

15. The device for implementing the heating method according to claim 12, wherein the medium wave infrared irradiation heating apparatus is fixedly connected with the external corresponding irradiation distance adjuster by a bracket arranged on the heating apparatus.

16. The device for implementing the heating method according to claim 12, wherein the medium wave infrared pulse irradiation heating apparatus is fixedly connected with the external corresponding irradiation distance adjuster by the bracket arranged on the heating apparatus.

17. The device for implementing the heating method according to claim 15, wherein one end of an adjusting rod in the irradiation distance adjuster is connected with the bracket, through holes are uniformly distributed on the adjusting rod, the other end of the adjusting rod is nested in a guide tube with a through hole, the guide tube is fixedly connected with the wall of a drying tunnel, and the guide tube and the adjusting rod are connected by a fixed pin on the outer side of the wall of the drying tunnel.

18. The device for implementing the heating method according to claim 16, wherein one end of an adjusting rod in the irradiation distance adjuster is connected with the bracket, through holes are uniformly distributed on the adjusting rod, the other end of the adjusting rod is nested in a guide tube with a through hole, the guide tube is fixedly connected with the wall of a drying tunnel, and the guide tube and the adjusting rod are connected by a fixed pin on the outer side of the wall of the drying tunnel.

19. The device for implementing the heating method according to claim 12, wherein the medium wave infrared irradiation heating apparatus is connected with a melting-section voltage regulator, and the medium wave infrared pulse irradiation heating apparatus is connected with a curing-section voltage regulator.

20. The device for implementing the heating method according to claim 12, wherein the top of the inner cavity of the drying tunnel is provided with an air blow pipe, the bottom of the inner cavity of the drying tunnel is provided with an air suction pipe, and the air blow pipe and the air suction pipe are respectively connected with a fan.

21. device for implementing the heating method according to claim 12, wherein the minimum vertical distance between the medium wave infrared heating tube and the single side of a heated board is 120-200 mm.
